(19) United States
(12) Patent Application Publication
(10) Pub. No.: US 2005/0196059 A1
(43) Pub. Date: Sep. 8, 2005

(54) Image input apparatus and inspection apparatus

(76) Inventors: Hiromu Inoue, Yokohama-shi (JP); Tsuneo Terasawa, Ome-shi (JP); Shinichi Imai, Tokyo (JP); Takehiko Nomura, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/064,014

(22) Filed: Feb. 24, 2005

(30) Foreign Application Priority Data
Feb. 24, 2004 (JP) 2004-048117

(51) Int. Cl. G06K 9/36

(52) U.S. Cl. 382/240

(57) ABSTRACT

An image input apparatus for inputting an image of an object and outputting the image as an electric signal, the image input apparatus comprises a stage which supports the object, a laser interferometer which measures a position of the stage, a light source which emits a pulse light, an illumination optical system which irradiates the object with an illuminating light, a sensor which converts an image-formed optical image into an electric image signal, an imaging optical system which forms an image of the object on the sensor, a synchronization control circuit which controls a light-emission interval of the light source and synchronization of the sensor on the basis of position information of the laser interferometer, a light quantity monitor which measures a quantity of light, and a light quantity correction circuit which corrects the electric image signal on the basis of an output of the light quantity monitor.

### CROSS-REFERENCE TO RELATED APPLICATIONS

This application is based upon and claims the benefit of priority from prior Japanese Patent Application No. 2004-048117, filed Feb. 24, 2004, the entire contents of which are incorporated herein by reference.

### BACKGROUND OF THE INVENTION

1. Field of the Invention

The present invention relates to an image input apparatus for picking up an image of an object, and an inspection apparatus for inspecting an object by using the image input apparatus, and in particular, to an apparatus for precisely picking up an image of the object, and an apparatus for precisely inspecting and measuring the object, with respect to an object having a fine pattern formed thereon.

2. Description of the Related Art

In an inspection apparatus for pattern of a photomask, a wafer, or the like, it is necessary to inspect with the resolution of the optical system being improved by using an ultraviolet light source and an optical system in order to improve the defect detecting sensitivity. A laser light source and a plasma light source excited from a laser light source are used as the light source of a ultraviolet range. Most of these light sources are pulse light sources. On the other hand, as a sensor for obtaining an electric image signal of a photomask and a wafer which are objects to be inspected, an area sensor, a linear sensor, and a TDI (Time Delay and Integration) sensor are used. In particular, because a TDI sensor can input an image at a high speed, if the performance of sensitivity at the ultraviolet range is satisfied, a TDI sensor may be an optimum sensor for use in a pattern inspection apparatus.

As the pattern inspection apparatus, for example, apparatus shown in FIGS. 14 to 16 have been known. For example, as shown in FIG. 14, a technology of emitting a pulse laser in accordance with an image fetching interval of an area type CCD sensor has been known (for example, in Jpn. Pat. Appln. KOKAI Publication No. 08-334315). In FIG. 14, reference numeral 200 denotes an excimer laser, 201 denotes a light-emission control section, 202 denotes a CCD camera, 203 denotes a half mirror, 204 and 205 denote lenses, and reference symbol W denotes a wafer serving as an object to be inspected. In this apparatus, because an image fetching speed of the area type CCD camera 202 is slow, there are the problems a rate of the inspection speed is limited, and it is necessary to correct a change in a quantity of laser light generated during the time of fetching an image by the CCD camera.

Further, as shown in FIG. 15, a technology of synchronizing a TDI sensor while emitting pulse laser at a uniform interval has been known (for example, Jpn. Pat. Appln. KOKAI Publication No. 10-171965). In FIG. 15, reference numeral 210 denotes a pulse laser, 211 denotes a synchronization control circuit, 212 denotes a TDI sensor, 213 denotes a stage, 214 denotes a mirror, 215 and 216 denote lenses, and reference symbol M denotes a photomask serving as an object to be inspected. In this case, when a change in the speed of the stage 213 is brought about, there is the problem that the resolution of an image obtained by the TDI sensor 212 deteriorates.

Moreover, as shown in FIG. 16, a technology of controlling a driving amount of a stage in accordance with a light-emission interval of pulse laser has been known (for example, refer to Jpn. Pat. Appln. KOKAI Publication No. 11-311608). In FIG. 16, reference numeral 220 denotes a pulse laser, 221 denotes a control system, 222 denotes a TDI sensor, 223 denotes a stage, 224 denotes a mirror, 225 and 226 denote lenses, and reference symbol M denotes a photomask serving as an object to be inspected. In this case, even if a driving amount of the stage 223 is controlled in accordance with a light-emission interval of the pulse laser, because there is mechanical and electric delay in the control, it is difficult for the stage 223 to be accurately synchronized a driving speed of the TDI sensor 222.

In the pattern inspection apparatus described above, because a change in the speed of the stage and a change in the quantity of light of the pulse light source cannot be corrected, the resolving power of a signal output from a sensor deteriorates, or an output level changes. Therefore, the pattern inspection apparatus is not suitable for a case in which a fine pattern of a photomask, a wafer, or the like of a semiconductor is precisely inspected.

### BRIEF SUMMARY OF THE INVENTION

An object of the present invention is to precisely input an image of an object having a fine pattern or the like formed thereon.

According to an aspect of the present invention, there is provided an image input apparatus for inputting an image of an object and outputting the image as an electric signal, the image input apparatus comprising: a stage which supports the object; a driving section which carries out positioning of the stage; a laser interferometer which measures a position of the stage; a light source which emits a pulse light so as to synchronize a synchronization signal that determines a light-emission interval; an illumination optical system which irradiates the object supported by the stage with an illuminating light from the light source; a sensor which converts an image-formed optical image into an electric image signal; an imaging optical system which forms a magnified projected image of the object on the sensor; a synchronization control circuit which controls a light-emission interval of the light source and synchronization of the sensor on the basis of position information of the laser interferometer; a light quantity monitor which measures a quantity of light of the illuminating light from the light source; and a light quantity correction circuit which corrects the electric image signal on the basis of an output of the light quantity monitor.

According to the present invention, an image of the object can be precisely fetched by correcting a change in the speed of the stage which supports the object, and by correcting a change in the quantity of light of the light source which illuminates the object.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an explanatory diagram showing a configuration of an image input apparatus according to a first embodiment of the present invention;

FIG. 2 is an explanatory diagram showing a pixel structure of a TDI sensor built in the image input apparatus;

FIG. 3 is an explanatory diagram showing a data readout clock signal of the TDI sensor;

FIG. 4 is a block diagram showing a configuration of a synchronization control circuit built in the image input apparatus;

FIG. 5 is a block diagram showing a configuration of a light quantity correction circuit built in the image input apparatus;

FIG. 6 is an explanatory diagram showing results when synchronization control is carried out by the synchronization control circuit;

FIG. 7 is an explanatory diagram showing results when synchronization control is not carried out by the synchronization control circuit;

FIG. 8 is an explanatory diagram showing a relationship between a transition of the quantities of light of a pulse light and integration ranges of the quantities of light;

FIG. 9 is an explanatory diagram showing a transition of integrated average values of the quantities of light of a pulse light;

FIG. 10 is an explanatory diagram showing a configuration of a mask inspection apparatus in which an image input apparatus according to a second embodiment of the present invention is incorporated;

FIG. 11 is a cross sectional view showing steps of manufacturing a mask;

FIG. 12 is an explanatory diagram showing a schematic view of multilayer film blanks;

FIG. 13 is an explanatory diagram showing a defective part of the multilayer film blanks;

FIG. 14 is an explanatory diagram showing one example of a conventional image input apparatus;

FIG. 15 is an explanatory diagram showing one example of a conventional image input apparatus; and

FIG. 16 is an explanatory diagram showing one example of a conventional image input apparatus.

### DETAILED DESCRIPTION OF THE INVENTION

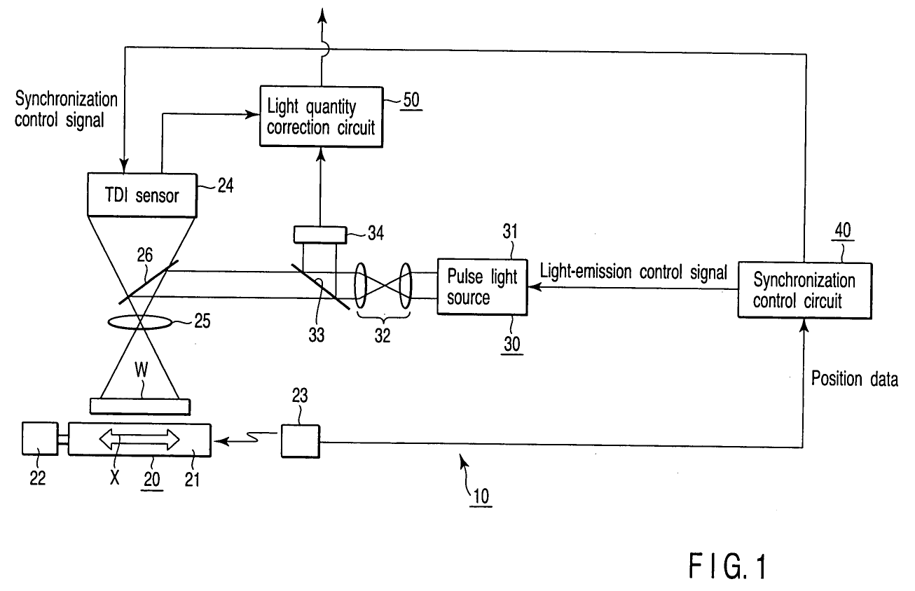

FIG. 1 is an explanatory diagram showing a configuration of an image input apparatus 10 according to a first embodiment of the present invention. The image input apparatus 10 has an image input section 20, an illumination section 30, a synchronization control circuit 40, and a light quantity correction circuit 50. The image input section 20 outputs a magnified optical image of an object as an electric image signal. The illumination section 30 illuminates an object. The synchronization control circuit 40 generates a synchronization control signal (a scan clock) of a TDI sensor 24 on the basis of position data of a laser interferometer 23, and controls a light-emission interval of a pulse light source 31. The light quantity correction circuit 50 offsets a change in a level of a quantity of light.

The image input section 20 has a stage 21 for supporting a wafer W serving as an object, a driving mechanism 22 for moving the stage 21 in the direction of the arrow X in FIG. 1, the laser interferometer 23 for precisely detecting the position of the stage 21, the Time Delay and Integration (TDI: storage type) sensor 24 disposed so as to face the stage 21, and an imaging optical system lens 25 and a half mirror 26 which are disposed between the stage 21 and the TDI sensor 24.

The TDI sensor 24 has a function of electrically storing a faint optical magnified image of an object obtained by an imaging optical system, and converting the image into an electric image signal, thereby outputting the signal. A pixel structure of the TDI sensor 24 will be described later.

The illumination section 30 has a pulse light source 31, an illumination optical system 32 for inducing an illuminating light from the pulse light source 31 to the half mirror 26, a half mirror 33 provided between the illumination optical system 32 and the half mirror 26, and a light quantity monitor 34 disposed at a position to be reflected from the half mirror 33.

The pulse light source 31 emits a pulse light in synchronous with a light-emission control signal from the synchronization control circuit 40, and a laser light source or a light source excited from a laser light source is used as the pulse light source. The pulse light emitted from the pulse light source 31 is irradiated onto the wafer W on the stage 21 via the illumination optical system 32. The light quantity monitor 34 measures a quantity of light of the pulse light, and outputs it to the light quantity correction circuit 50.

The synchronization control circuit 40 generates a synchronization control signal of the TDI sensor 24 on the basis of the position data of the stage 21 obtained by the laser interferometer 23, and generates a light-emission control signal for controlling a light-emission interval of the pulse light source 31. The details thereof will be described later.

The light quantity correction circuit 50 has a function of offsetting a change in a level of an electric image signal due to a change in a quantity of light by correcting a level of a signal output from the TDI sensor 24 on the basis of an output of the light quantity monitor 34.

Next, the pixel structure of the TDI sensor 24 will be described. The TDI sensor 24 is an area sensor having N-stage exposure areas in an integration direction perpendicular to a pixel direction, and a sensor which can output electric charges of an amount of a number of integrated stages by causing electric charges to be transferred one stage by one stage in the integration direction for each scan.

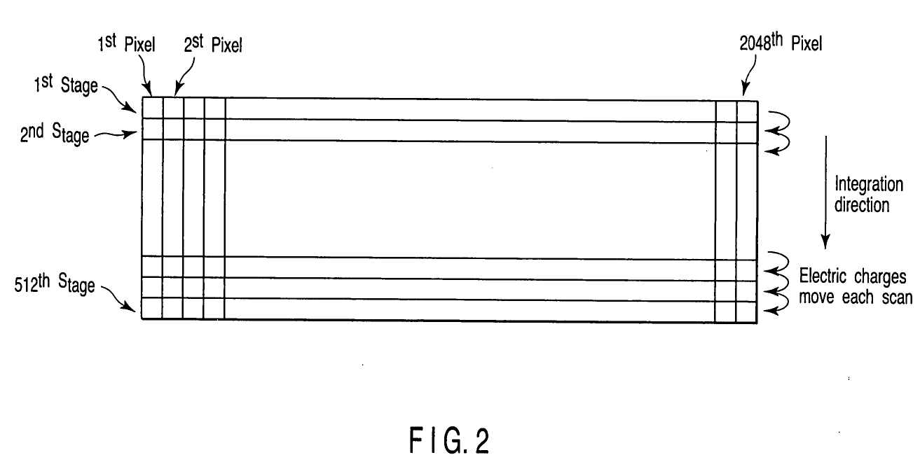

FIG. 2 is an example of the TDI sensor 24 in which there are 2048 pixels in the pixel direction, and the number of the integrated stages (the number of pixels in the integration direction) is 512 stages, and suppose that the integration direction is the lower side, electric charges are made to be transferred downward. Note that, suppose that the integration direction is the upper side by switching the transferring direction, electric charges are to be transferred upward.

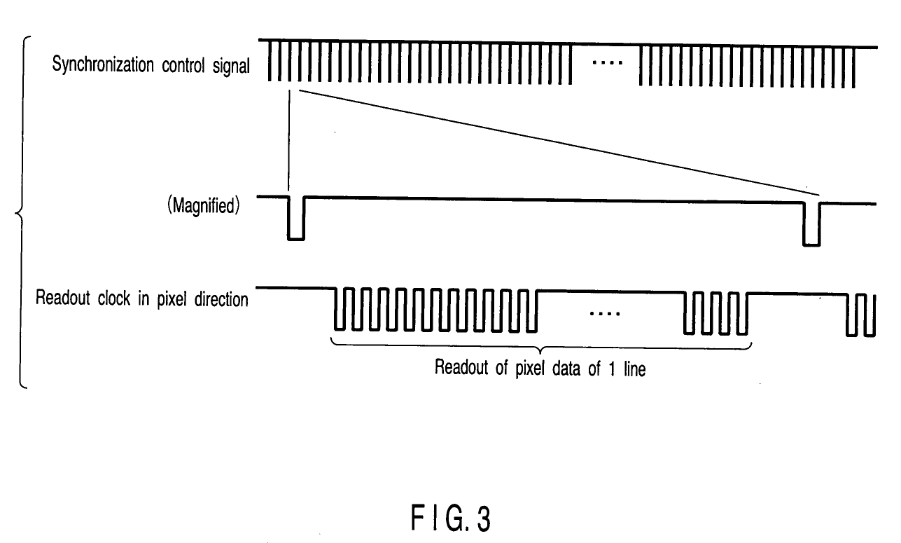

FIG. 3 is a diagram for explanation of a readout clock of the TDI sensor 24. The synchronization control signal is a clock for transferring electric charges in the integration direction of the sensor. The readout clock in the pixel direction is a data readout clock in the pixel direction at a sensor output stage. There is a number of clock pulses required for reading out data in one cycle of the synchronization control signal.

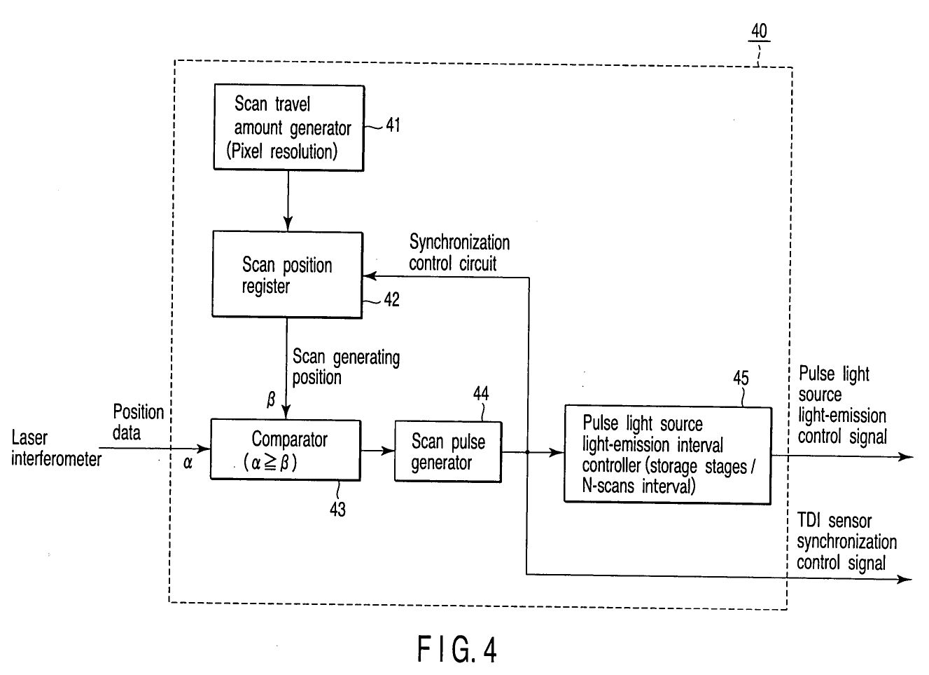

As shown in FIG. 4, the synchronization control circuit 40 has a scan travel amount generator 41, a scan position register 42, a comparator 43, a scan pulse generator 44, and a pulse light source light-emission interval controller 45. The scan travel amount generator 41 generates a scan travel amount. The scan position register 42 updates by adding a scan travel amount each scan. The comparator 43 compares a scan generating position (β) provided from the scan position register 42 and position data (α) from the laser interferometer 23. The scan pulse generator 44 generates a synchronization control signal of the TDI sensor 24 when it is α≧β at the comparator 43. The pulse light source light-emission interval controller 45 makes a light-emission control signal of the pulse light source 31 at each storage stages/N-scans interval where the scan is the synchronization control signal. Here, N is an integer greater than or equal to 1.

The synchronization control circuit 40 configured as described above generates the synchronization control signal of the TDI sensor 24 at a time when a travel distance of the stage 21 reaches a scan travel amount serving as the pixel resolution of the TDI sensor 24 on the basis of the position data of the laser interferometer 23, and can carry out the control of light-emitting of the pulse light source at a time interval for which the stage 21 has moved a distance corresponding to the number of storage stages/N.

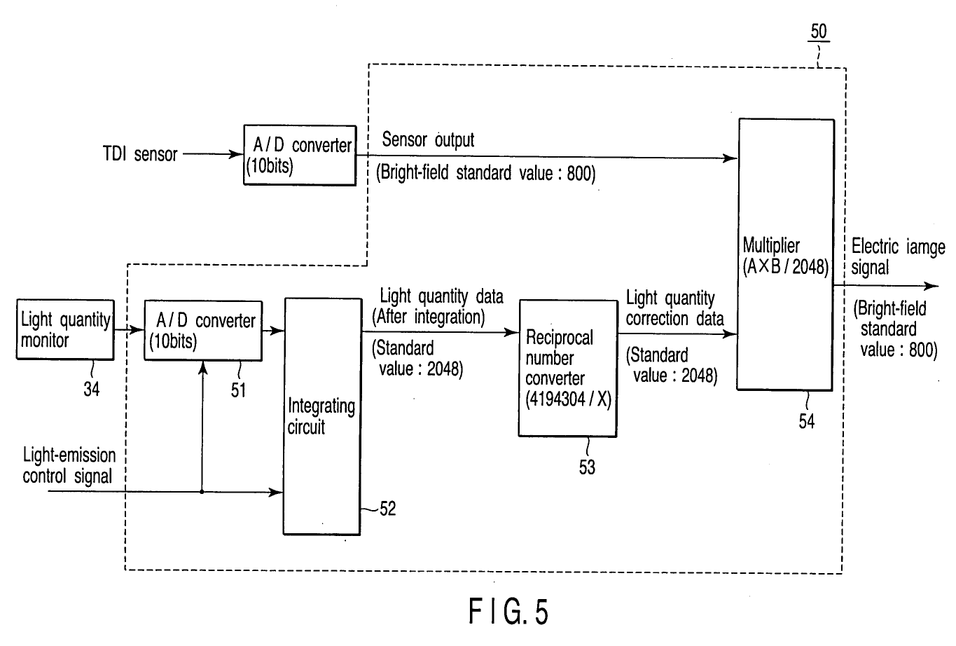

As shown in FIG. 5, the light quantity correction circuit 50 has an A/D converter 51, an integrating circuit 52, a reciprocal number converter 53, and a multiplier 54. The A/D converter 51 analog-to-digital converts an output signal from the light quantity monitor 34. The integrating circuit 52 determines an integrated average value of the number of light-emissions in the number of storage stages of the TDI sensor 24 so as to synchronize output data from the A/D converter 51 and a light-emission control signal. The reciprocal number converter 53 reciprocally converts the light quantity data after integrating by the integrating circuit 52, and outputs light quantity correction data. The multiplier 54 multiplies A/D output data of the TDI sensor 24 and the light quantity correction data. The integrating circuit 52 integrates the quantities of light of the pulse light in the number of storage stages of the TDI sensor 24, and corrects the output data of the TDI sensor 24 on the basis of the integrated value, whereby a change in the output of the TDI sensor 24 due to a change in the light quantity of the pulse light can be offset.

In the thus configured image input apparatus 10, an image of the wafer W is acquired as follows. Namely, the object M for inspection of a photomask or the like is fixed onto the stage 21, and moves in accordance with the movement of the stage 21. The position of the stage 21 is precisely measured by the laser interferometer 23, and the position data thereof is input to the synchronization control circuit 40.

The synchronization control circuit 40 generates the synchronization control signal of the TDI sensor 24 so as to synchronize a time interval for which the stage 21 moves by a scan travel amount of the TDI sensor 24, i.e., an amount of the pixel resolution on the basis of the position data. Further, the synchronization control circuit 40 generates a pulse laser light by transmitting a light-emission control signal to the pulse light source 31 at a time interval every number of storage stages/N-scans.

The pulse laser light emitted from the pulse light source 31 is irradiated onto the wafer W via the illumination optical system 32. The image of the wafer W is input to the TDI sensor 24, and is converted into electric image signal. Thereafter, the electric image signal is input to the light quantity correction circuit 50.

The light quantity monitor 34 measures the quantity of light from the pulse light source 31 at an interval synchronized with the light-emission control signal, and outputs the quantity of light to be irradiated onto the wafer W to the light quantity correction circuit 50. The light quantity correction circuit 50 determines an integrated average value of a number of light emissions in the number of storage stages of the TDI sensor 24 on the basis of the light quantity data from the light quantity monitor 34, corrects the output data of the TDI sensor 24, and corrects the change in the output of the sensor due to the change in the light quantity of the pulse laser light.

The output stored so as to synchronize the position of the stage 21, the output including the image information of the wafer W of the TDI sensor 24 is made to be an electric image signal in which the light quantity of the light quantity changing element is corrected. The electric image signal is made to be data without any light quantity changing element and any synchronization gap, and with a good S/N ratio.

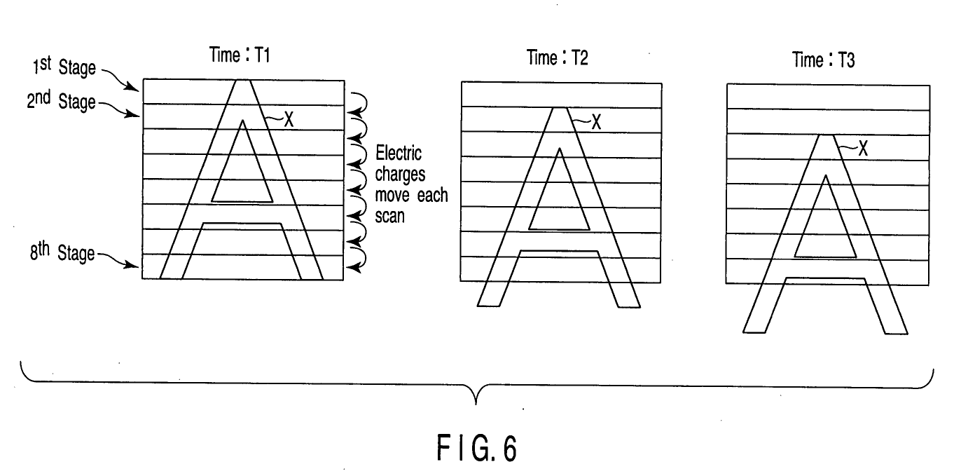

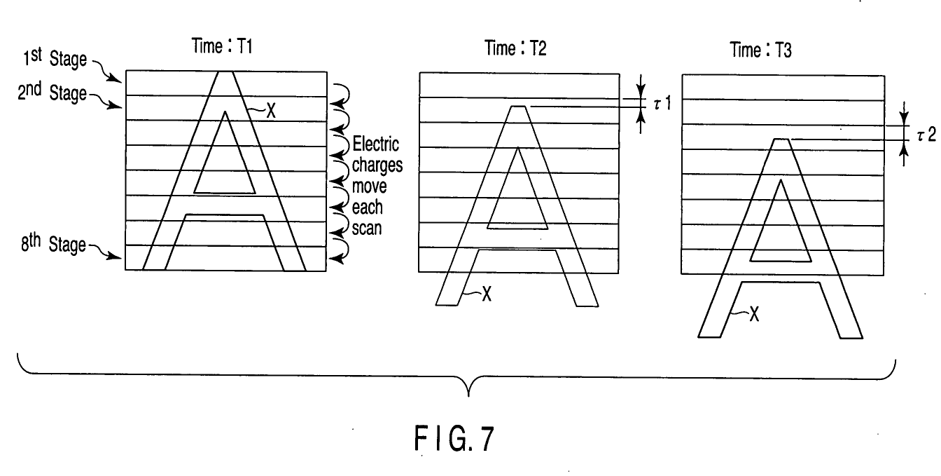

FIGS. 6 and 7 show a synchronization control principle for fetching images without any synchronization gap, and are explanatory diagrams showing position relationships between an object X and the image area of the TDI sensor 24 at time T1 through time T3. Note that FIG. 6 shows a case in which synchronization control is carried out, and FIG. 7 shows a case in which synchronization control is not carried out in order to compare therewith. In order to simplify the description, a case in which the number of the integrated stages of the TDI sensor 24 is made to be 8 stages, and a pulse light is emitted each scan is shown.

In FIG. 6, it is shown that time has passed from the time T1 (the first light-emission and the first scan) to the time T2 (the second light-emission and the second scan), and the object X moves by a scan travel amount (a distance of one stage of the number of storage stages). It is shown that, even when it is the time T3 (the third light-emission and the third scan), the scans and the light-emission intervals are accurately synchronized with one another.

In contrast thereto, in FIG. 7, because synchronization control is not carried out, there is no synchronization gap between the object X and the position of the sensor at the time T1. However, because the scans and the light-emission intervals are bit synchronized with respect to the scan travel amount (a distance of one stage of the number of storage stages) at the time T2, the object X is shifted downward by T1 which is a synchronization gap amount. At the time T3, the object X is further shifted by τ2 which is a synchronization gap amount, and the amount is increased. Therefore, when electric charges of the amount of the number of storage stages on the TDI sensor 24 are stored in the state in which synchronization control between a light-emission interval and a scan interval is not carried out, the resultant electric image signal is obtained in a state of being blurring by an amount of the synchronization gap.

As described above, the amount of the number of storage stages of electric charges on the TDI sensor 24 is stored and output, and whereby the output electric image signal can be obtained in a state in which there is no synchronization gap and the resolution thereof is extremely high. Note that the light-emission interval of the pulse light is set to a time interval synchronized with scans (which corresponds to a case in which N=the number of storage stages in light-emission control of the pulse light source every number of storage stages/N-scans). However, N may be set to an integral value except for the number of storage stages.

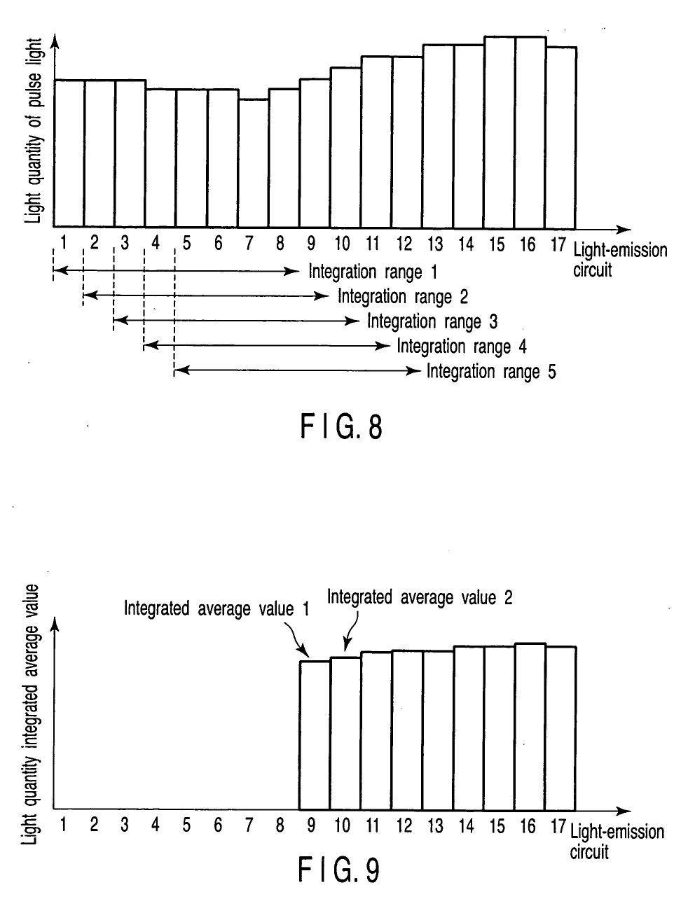

Next, the light quantity correction principle for accurately determining a light quantity changing element of the pulse light in the image input apparatus 10 will be described. FIG. 8 shows a transition of the output of the light quantity monitor 34 at each light-emission of the pulse light and integration ranges of the quantities of light when the storage stages of the TDI sensor 24 are 8 stages, with a case in which a scan interval and a light-emission interval of the pulse light are the same.

FIG. 9 shows results that the quantities of light in the integration ranges of FIG. 8 are integrated at the integrating circuit 52 and the average values are calculated every scanning, i.e., at each light-emission interval. The integrated average values of the quantities of light correspond to a total quantity of light for a time stored at the TDI sensor 24. The reciprocals of the integrated average values are determined, and the output data of the TDI sensor 24 is corrected, whereby the light quantity changing element of the pulse light can be offset.

As described above, in the image input apparatus 10 according to the first embodiment, by generating a synchronization control signal and a pulse light source light-emission control signal, a change in the speed of the stage 21 for supporting the wafer W is offset, and a change in the quantity of light of the light source for illuminating the wafer W is offset. Accordingly, a projected image of an object to be inspected on which a fine pattern or the like is formed can be precisely input.

Note that, in the image input apparatus 10 according to the first embodiment, an imaging optical system by which a reflected optical image of the wafer W serving as an object is projected onto the TDI sensor 24 is shown. When the object is a transparent material body such as a photomask, however, it may be an imaging optical system by which an optical image permeated through the object is projected onto the TDI sensor 24.

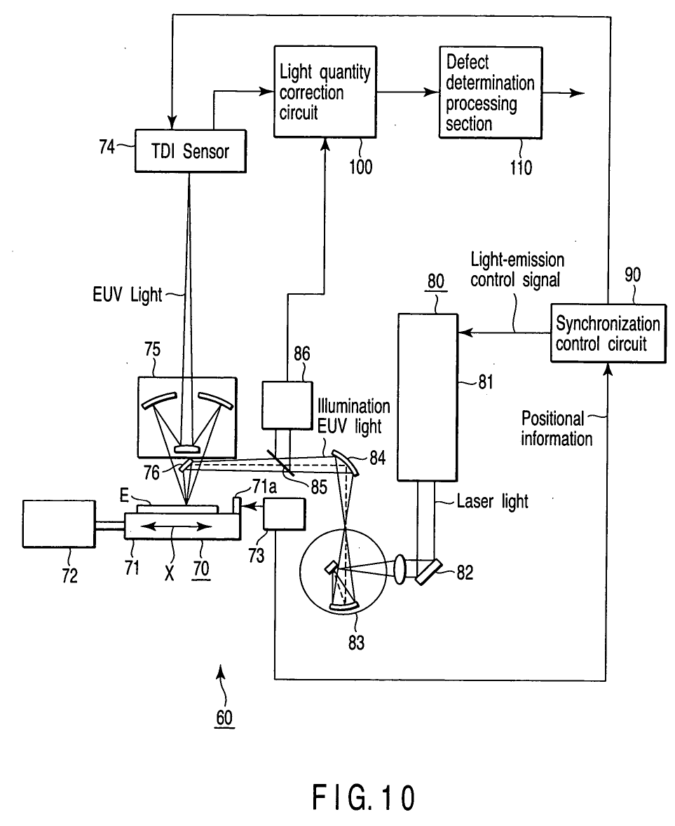

FIG. 10 is an explanatory diagram showing a configuration of a mask inspection apparatus 60 for an EUV mask according to a second embodiment of the present invention. The mask inspection apparatus 60 has an image input section 70, an illumination section 80, a synchronization control circuit 90, a light quantity correction circuit 100, and a defect determination processing section 110. The image input section 70 outputs a magnified optical image of an object as an electric image signal. The illumination section 80 illuminates an object. The synchronization control circuit 90 generates a synchronization control signal of the TDI sensor 24 on the basis of position data of the laser interferometer 73, and controls a light-emission interval of an LPP light source 83. The light quantity correction circuit 100 offsets a change in a level of a light quantity. The defect determination processing section 110 determines the presence/absence of a defect in an EUV mask on the basis of the determined electric image signal.

Note that, respectively, the image input section 70 has a function corresponding to the image input section 20 of the image input apparatus 10 according to the first embodiment, the illuminating section 80 has a function corresponding to the illumination section 30 of the image input apparatus 10, the synchronization control circuit 90 has a function corresponding to the synchronization control circuit 40 of the image input apparatus 10, and the light quantity correction circuit 100 has a function corresponding to the light quantity correction circuit 50 of the image input apparatus 10.

The image input section 70 has a stage 71 for supporting multilayer mask blanks E serving as an object, a driving mechanism 72 for moving the stage 71 in the direction of the arrow X in FIG. 10, the laser interferometer 73 for precisely detecting the position of the stage 71, the TDI (Time Delay and Integration) sensor 74 disposed so as to face the stage 71, and a darkfield magnification imaging optical system lens 75 and a mirror 76 which are disposed between the stage 71 and the TDI sensor 74, and which block off a specular reflected light. The TDI sensor 74 is configured in the same way as the TDI sensor 24 described above. The darkfield magnification imaging optical system lens 75 uses a Schwarzschild optical system in which two spherically shaped multilayer mirrors are combined.

The illumination section 80 has an excitation laser light source 81, an optical system 82 for inducing a laser light from the excitation laser light source 81, the LPP light source (laser excited plasma light source) 83 for generating an illumination EUV light by being excited by a laser light, an illumination optical system 84 for inducing the illumination EUV light from the LPP light source 83 to the mirror 76, a half mirror 85 provided between the illumination optical system 84 and the mirror 76, and a light quantity monitor 86 disposed at a position to be reflected from the half mirror 85. The light quantity monitor 86 measures a light quantity of a pulse light, and outputs it to the light quantity correction circuit 100.

The synchronization control circuit 90 has a function of generating a synchronization control signal of the TDI sensor 24 on the basis of position data of the laser interferometer 73, and a function of controlling a light-emission interval of the pulse light source. The light quantity correction circuit 100 has a function of correcting a level of an output signal of the TDI sensor 24 on the basis of an output of the light quantity monitor 86, thereby offsetting a change in a level of the output signal from the sensor due to a change in a quantity of light.

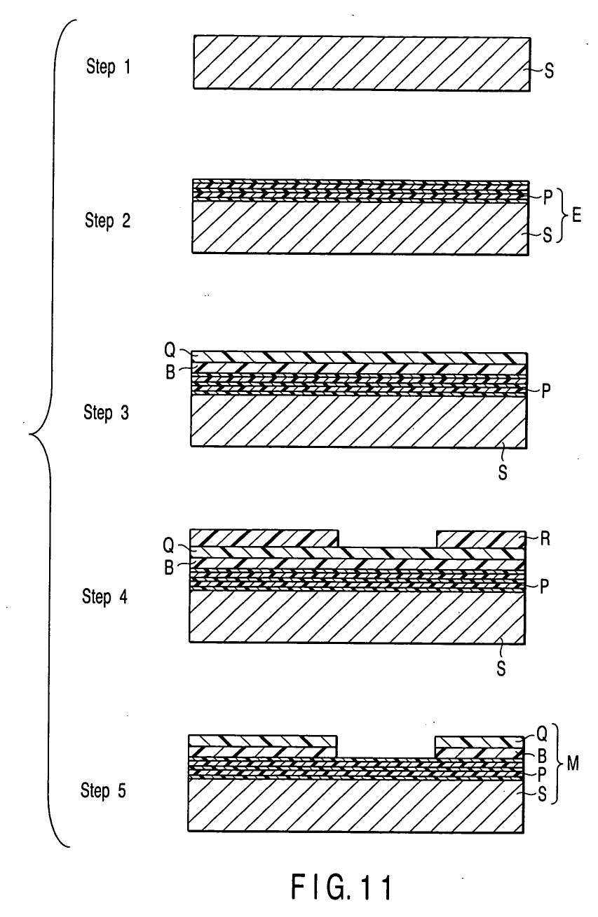

Next, the multilayer mask blanks E serving as an object to be inspected will be described. FIG. 11 is a diagram showing steps of manufacturing a reflection type mask M for transferring an LSI circuit pattern onto a semiconductor substrate by using an extreme ultraviolet (EUV) light whose wavelength is about 13.5 nm as an illuminating light.

An ultra-smooth substrate S hardly having any roughness is prepared in order to obtain a high reflectance (step 1), and a multilayer film P for reflecting an EUV light is formed on the ultra-smooth substrate S (step 2). This multilayer film P is formed by alternately laminating thin films such as, for example, silicon and molybdenum. The one obtained by forming the multilayer film P on the surface of the ultra-smooth substrate S is generally called multilayer mask blanks E. Next, an absorber Q which will be a non-reflective portion of the reflection type mask M is formed so as to put a buffer layer B therebetween (step 3). As a material of the absorber Q, a simple substance or a compound of metal, nonmetal, and semiconductor materials such as tungsten, tantalum, gold, chrome, titanium, germanium, nickel and cobalt is used.

Thereafter, a resist film R is formed on the absorber Q in order to form a desired absorber pattern, and a resist pattern is formed by an electron beam drawing technology or a lithography technology using a light, a laser, an X-ray, or an ion beam (step 4). Finally, the absorber Q is processed by reactive ion etching or the like by using the resist film R having the resist pattern formed thereon as a mask, and the resist film R is eliminated to form an absorber pattern (step 5). This absorber pattern becomes an LSI circuit pattern.

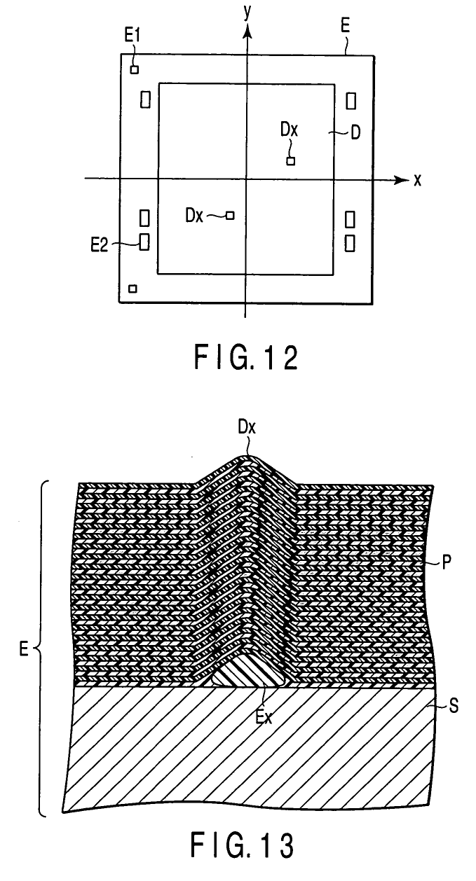

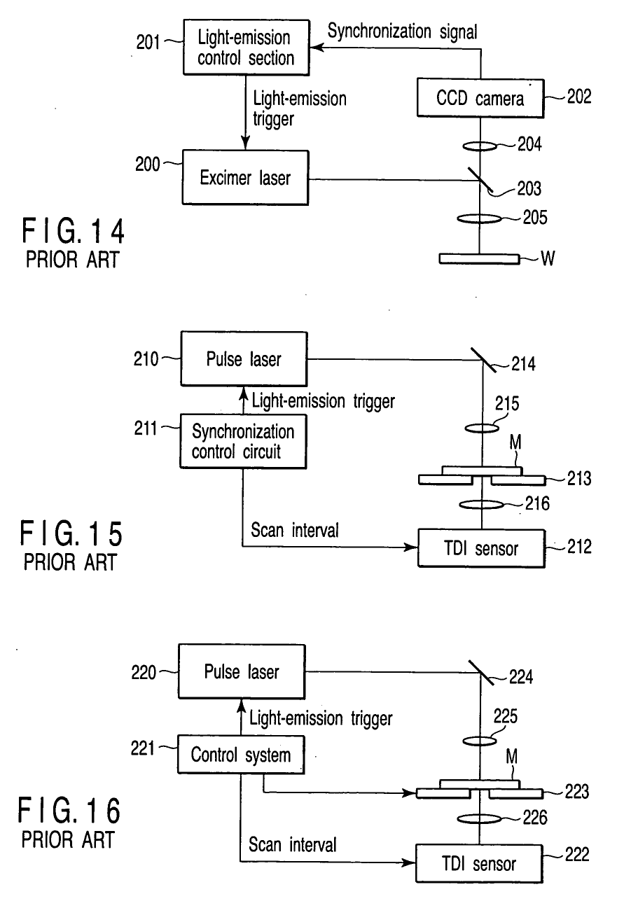

FIG. 12 is a diagram showing the multilayer mask blanks E formed in the step 2. FIG. 12 is a diagram showing a schematic view of the multilayer mask blanks E, and a device pattern region D is formed on the surface thereof. Dx denotes a phase defective portion. Note that mask alignment marks E1 and mask wafer alignment marks E2 are formed. If there is fine irregularity on the surface of the multilayer mask blanks E, there is a possibility that the irregularity becomes the phase defective portion Dx.

FIG. 13 is a diagram showing the cross-section of the phase defective portion Dx. There is a high possibility that the fine irregularity on the surface are brought about when the multilayer film P is formed as a micro-foreign matter Ex exists on the surface of the ultra-smooth substrate S, or the like.

The mask inspection apparatus 60 carries out inspection of the mask M as follows. Namely, a pulse laser light emitted from the excitation laser light source 81 generates an EUV light by irradiating a target in the LPP light source 83. This EUV light is fetched and made to be an illumination EUV light, and is irradiated on the multilayer mask blanks E.

When there is a phase defect on the multilayer mask blanks E, the illumination EUV light is scattered, and is condensed upon the TDI sensor 74 via the darkfield magnification imaging optical system. When there is no defect, the illumination EUV light is not scattered on the multilayer mask blanks E, and only a specular reflected light goes toward the darkfield magnification imaging optical system. However, because the specular reflected light is blocked, the specular reflected light does not reach the TDI sensor 74. Namely, the scattered light is formed to be an image on only a portion where there is a defect. Because the stage 71 for supporting the multilayer mask blanks E moves in a predetermined direction by the driving section 72, defect inspection at a predetermined region can be carried out by processing the output data from the TDI sensor 74.

The moved position of the stage 71 is detected as a position of a mirror 71a fixed to the stage 71 by the laser interferometer 73. The laser interferometer 73 determines position data of the stage 71 by a predetermined position resolution, and outputs it to the synchronization control circuit 90. The synchronization control circuit 90 generates a synchronization control signal of the TDI sensor 74 so as to synchronize a time interval for which the stage 71 moves by a scan travel amount of the TDI sensor 24, i.e., an amount of the pixel resolution on the basis of the position data. Further, the synchronization control circuit 90 generates an excitation laser light by transmitting a light-emission control signal to the excitation laser light source 81 at a time interval every number of storage stages/N-scans, and emits an EUV light from the LPP light source 83.

The light quantity monitor 86 measures the light quantity of the EUV light from the LPP light source 83 at an interval synchronized with the light-emission control signal of the excitation laser light source 81, and outputs the light quantity of the EUV light for irradiating the multilayer mask blanks E to the light quantity correction circuit 100. The light quantity correction circuit 100 determines an integrated average value of a number of light-emissions in the number of storage stages of the TDI sensor on the basis of the light quantity data from the light quantity monitor 86, corrects the output data of the TDI sensor 74, and corrects the change in the output from the sensor due to the change in the light quantity of the EUV light.

The output of the TDI sensor which has been stored so as to synchronize the position of the stage 71, and in which the quantity of light of the light quantity changing element of the EUV light is corrected becomes image data including the defect information of the multilayer mask blanks E. Because this image data is data without any light quantity changing element and any synchronization gap, and with a good S/N ratio, a defect inspection of the multilayer mask blanks E can be carried out by carrying out, for example, determining processing in which a value greater than or equal to a threshold value is regularly determined to be a defect.

As described above, in the mask inspection apparatus 60 according to the second embodiment, by generating a synchronization control signal and a light source light-emission control signal, a change in the speed of the stage 71 for supporting the multilayer mask blanks E is offset, and a change in the quantity of light of the LPP light source 83 for illuminating multilayer mask blanks E is offset. Accordingly, an electric image signal with little noise can be input to the defect determination processing section 110, and a defect can be highly accurately found.

Note that, in the above-described embodiment, a TDI sensor is used as the sensor. However, when an image is fetched due to the stage being sequentially moved by using an area sensor and a pulse light source, the embodiment can be applied to a case in which the number of storage stages is made to be the number of pixels in the direction in which the stage of the area sensor is sequentially moved, and N is made to be one. Further, the image input apparatus of the invention is disclosed on the assumption that the inspection apparatus for a semiconductor is applied thereto. However, the image input apparatus of the invention can be applied to an adapted example in which highly accurate image measurement/inspection is carried out.

Note that the present invention is not limited to the above-described embodiments as are, and constituent elements can be modified and embodied within a range which does not deviate from the gist of the invention at the practical phase. Moreover, various inventions can be formed by an appropriate combination of a plurality of constituent elements disclosed in the above-described embodiments. For example, several constituent elements may be eliminated from all of the constituent elements shown in the embodiments. Moreover, constituent elements over the different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image input apparatus for inputting an image of an object and outputting the image as an electric signal, the image input apparatus comprising:
a stage which supports the object;
a driving section which carries out positioning of the stage;
a laser interferometer which measures a position of the stage;
a light source which emits a pulse light so as to synchronize a synchronization signal that determines a light-emission interval;
an illumination optical system which irradiates the object supported by the stage with an illuminating light from the light source;
a sensor which converts an image-formed optical image into an electric image signal;
an imaging optical system which forms a magnified projected image of the object on the sensor;
a synchronization control circuit which controls a light-emission interval of the light source and synchronization of the sensor on the basis of position information of the laser interferometer;
a light quantity monitor which measures a quantity of light of the illuminating light from the light source; and
a light quantity correction circuit which corrects the electric image signal on the basis of an output of the light quantity monitor.

2. An image input apparatus according to claim 1, wherein
the sensor is a storage type sensor,
the synchronization control circuit is a pulse light source light-emission interval controller which controls a light-emission interval of a pulse light source so as to synchronize a time interval for which the stage moves a given distance, and
a scan pulse generator which drives the storage type sensor so as to synchronize a position to which the stage has moved.

3. An image input apparatus according to claim 2, wherein
the storage type sensor is TDI (Time Delay and Integration) sensor.

4. An image input apparatus according to claim 1, wherein
the sensor is a storage type sensor, and
the light quantity correction circuit determines an integrated average value, in a storage time of the storage type sensor, of a measured quantity of light, and corrects a level of an output signal of the storage type sensor.

5. An image input apparatus according to claim 4, wherein
the storage type sensor is TDI (Time Delay and Integration) sensor.

6. An image input apparatus according to claim 1, wherein
the sensor is a storage type sensor, and
the synchronization control circuit causes the pulse light source to emit light so as to synchronize a time interval for which the stage has moved a distance corresponding to a number of stages that a number of storage stages of the storage type sensor is multiplied by a reciprocal number of an integer on the object.

7. An image input apparatus according to claim 6, wherein
the storage type sensor is TDI (Time Delay and Integration) sensor.

8. An image input apparatus according to claim 1, wherein the light source is a laser light source or a light source excited by a laser light source.

9. An inspection apparatus comprising:
an image input apparatus which inputs an image of an object and which outputs the image as an electric signal, the image input apparatus comprising:
a stage which supports the object;
a driving section which carries out positioning of the stage;
a laser interferometer which measures a position of the stage;
a light source which emits a pulse light so as to synchronize a synchronization signal that determines a light-emission interval;
an illumination optical system which irradiates the object supported by the stage with an illuminating light from the light source;
a sensor which converts an image-formed optical image into an electric image signal;
an imaging optical system which forms a magnified projected image of the object on the sensor;
a synchronization control circuit which controls a light-emission interval of the light source and synchronization of the sensor on the basis of position information of the laser interferometer;
a light quantity monitor which measures a quantity of light of the illuminating light from the light source;
a light quantity correction circuit which corrects the electric image signal on the basis of an output of the light quantity monitor; and
a defect processing section which detects a pattern defect of an object on the basis of the corrected electric image signal.

10. An inspection apparatus according to claim 9, wherein the object is a photomask or a semiconductor wafer.
